(19) United States
(12) Patent Application Publication
(10) Pub. No.: US 2005/0098907 A1
(43) Pub. Date: May 12, 2005

(54) Systems and methods for automatic carburetor enrichment during cold start

(76) Inventors: Karl Richard, Rock Forest (CA); Bruno Schuehmacher, Richmond (CA)

Correspondence Address: PILLSBURY WINTHROP, LLP, P.O. BOX 10500, MCLEAN, VA, 22102, US

(21) Appl. No.: 10/467,451

(22) PCT Filed: Mar. 12, 2001
(86) PCT No.: PCT/CA01/00307

Related U.S. Application Data
(60) Provisional application No. 60/267,194, filed on Feb. 8, 2001.

(51) Int. Cl. F02M 1/10

(52) U.S. Cl. 261/39.1

(57) ABSTRACT

An automatic carburetor (20) enrichment system that controls the air-fuel mixture during cold start of an engine (10) having a carburetor including a fuel bowl (22) and an induction passage (23), includes a sensor (50) that provides a signal indicative of an engine temperature at engine start, a fuel line (30) connected between the fuel bowl (22) and the induction passage, a solenoid valve (40) disposed in the fuel line, and a controller (10) that receives the signal and sets a duty cycle of the solenoid valve associated with the engine temperature to increase the air-fuel ratio of the air-fuel mixture at engine start. The automatic carburetor enrichment system reduces cranking time during cold start, eliminates the need for driver input during cold start, prevents engine stalling without assistance from the operator during the warm up phase, provides a simpler, more cost effective and reliable carburetor enrichment, provides self-drowning protection without the use of an electronic idle switch and eliminates the risk of engine drowning when the engine is cranked with the choke ON and the ignition switches OFF.

### BACKGROUND OF THE INVENTION

1. Field of the Invention

The present invention relates to systems and methods for automatic carburetor enrichment during cold start of an engine.

2. Description of the Related Art

In internal combustion engines having carburetor controlled fuel supplies, for example, engines used in vehicles such as snowmobiles, personal watercraft, and all terrain vehicles, the rate of fuel flow in a fixed or variable venturi carburetor is dependent on the pressure differential between the venturi and the fuel bowl, also known as the float bowl or float chamber. In a conventional float bowl carburetor the pressure differential is measured between the pressure in the fluid float chamber, which is normally atmospheric, and the pressure at the discharge orifice of the fuel metering system which is normally located in or adjacent the venturi in the induction passage.

For optimum combustion, the relationship between the mass air flow and the mass fuel flow delivered to the engine by the carburetor should be kept to a controllable rate. A fixed or variable venturi may be used to provide a constant relationship between the mass air flow and the mass fuel flow. As the air velocity in the induction passage increases, a pressure reduction, or vacuum, is created in the venturi. The pressure reduction creates a pressure differential between the induction passage and the fuel in the float chamber causing fuel to be drawn into the induction passage at a flow rate that is proportional to the pressure differential.

The pressure reduction is mainly a function of the air velocity through the induction passage. However, at a given velocity, the mass air flow rate is dependent on the air density which in turn is dependent on the barometric pressure and temperature. For a given air velocity, the induction passage delivers a reduced mass air flow at higher altitudes due to the reduced barometric pressure and correspondingly reduced air density. Operating the engine at higher altitudes thus causes the engine to be supplied with an over rich air-fuel mixture. Conversely, for a given air velocity, the induction passage delivers an increased mass air flow at lower temperatures due to the increased air density. Operating the engine at lower temperatures thus causes the engine to be supplied with an over lean air-fuel mixture.

U.S. Pat. No. 5,021,198 to Bostelmann, the entire contents of which are herein incorporated by reference, discloses a carburetor with a high altitude compensator that includes a pressure splitter connected with the lower pressure of the venturi throat in the area where the fuel delivery line opens out and with the induction pressure in the area of the inlet end of the air flow passage. The pressure splitter includes a pressure line with two chokes that are connected in series. The fuel bowl is connected to the pressure line between the two chokes and one or both of the chokes is controlled as a function of the specific air density. The control system of U.S. Pat. No. 5,021,198 cannot provide an enriched air-fuel mixture during cold start

When the engine is cold it is difficult to start because it is difficult to create a sufficient amount of fuel vapor in the combustion chamber because atomization and vaporization are less effective at lower temperatures. It is therefore necessary to increase the amount of fuel in order to compensate for the lack of atomization. It has been known to increase the amount of fuel by using a manual primer or an air pump enrichment system at the carburetor.

U.S. application Ser. No. 08/948,064, the entire contents of which are hereby incorporated by reference, discloses an electronic compensation system for an internal combustion engine including a manifold connected to the float chamber and the venturi of each carburetor. A barometric pressure sensor and an engine temperature sensor provide signals to an electronic control unit that controls first and second solenoids connected to the manifold. During a cold start, the first solenoid is controlled to provide pressurized gas, provided by a pressure line in communication with the crankcase interior, from the manifold to the float chambers of the carburetors to increase the fuel flow and enrich the air-fuel mixture. As the engine temperature increases, the electronic control unit responds to signals from the engine temperature sensor to reduce the duty cycle of the first solenoid and thus reduce the supply of pressurized gas to the float chambers until the normal engine operating temperature is reached. The second solenoid is controlled during normal engine operation to apply the underpressure, or vacuum, from the venturis of the carburetors to the manifold to reduce the float chamber pressure to decrease the fuel flow when the air density is reduced, for example, at increased altitudes.

The electronic compensation system of U.S. application Ser. No. 08/948,064 requires the use of an air pump when the rotation speed of the engine c corresponds to idling or higher. While completely reliable during operation, condensation of fuel, oil, and water in the air pump decreases the reliability of the air pump. The electronic compensation system of U.S. application Ser. No. 08/948,064 also requires an expensive idle switch to signal the position of the throttle during idling to the electronic control unit and to limit fuel distribution to avoid flooding the engine. In addition, the electronic compensation system of U.S. application Ser. No. 08/948,064 requires the insertion of an impulse line from the interior of the crankcase to the air pump to activate a diaphragm of the air pump.

### SUMMARY OF THE INVENTION

There exists a need for an engine control system that automatically provides an enriched air-fuel mixture during cold start and that does not require a manifold and an air pump for providing pressurized gas to the float chamber and an impulse line for activating the diaphragm of the air pump. There also exists a need for an engine control system that automatically reduces the enriched air-fuel mixture as the engine operating temperature approaches a normal engine operating temperature and that does not require an idle switch for limiting the fuel distribution to the engine when in off-idle mode.

A system for automatic carburetor enrichment during cold start according to the present invention controls an air-fuel ratio of an air-fuel mixture supplied to an internal combustion engine during cold start, the engine having a carburetor and being supplied fuel from a fuel reservoir, for example a fuel bowl, and an induction passage, and includes a sensor that provides a signal indicative of an engine temperature at engine start, a fuel line connected between the fuel bowl and the induction passage, a solenoid valve disposed in the fuel line, and a controller that receives the signal and sets a duty cycle of the solenoid valve associated with the engine temperature to increase the air-fuel ratio of the air-fuel mixture at engine start

A method according to the present invention for controlling the air-fuel ratio of an air fuel mixture supplied to a carburetor of an internal combustion engine during cold start, the engine having a carburetor including a fuel bowl, a fuel line between the fuel reservoir and an induction passage of the carburetor, and a solenoid valve disposed in the fuel line, includes determining a temperature of the engine, determining a duty cycle of the solenoid valve associated with the determined temperature, setting the duty cycle of the solenoid valve to the associated duty cycle at an engine start time to increase the air-fuel ratio of the air-fuel mixture at engine start.

### BRIEF DESCRIPTION OF THE DRAWINGS

The present invention will further be described with reference to the accompanying drawings wherein:

FIG. 1 is a schematic illustration of an exemplary automatic carburetor enrichment system according to the present invention;

FIG. 2 is a graphical representation of an exemplary relationship between a solenoid duty cycle and an engine start time according to the present invention;

FIG. 3 is a graphical representation of a table including duty cycles values at various engine starting temperatures;

FIG. 4 is a graphical representation of a table including enrichment mode durations at various engine starting temperatures; and

FIG. 5 is a graphical representation of a value of the duty cycle slope at an idle threshold speed.

### DETAILED DESCRIPTION OF EXEMPLARY EMBODIMENTS

Various exemplary embodiments of the present invention will now be described in detail with reference to the drawings.

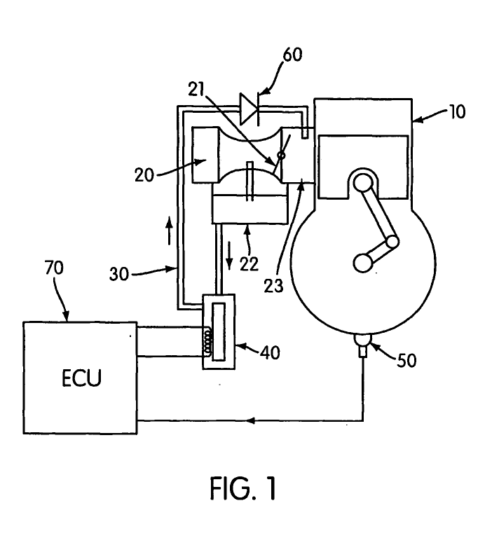

Referring to FIG. 1, an automatic carburetor enrichment system for an internal combustion engine 10 includes a carburetor 20 having a throttle valve 21. It should be appreciated that a carburetor having an air inlet of fixed size may also be used. The carburetor 20 also includes a float chamber 22 configured in the usual manner to ensure a constant fuel level within the chamber 22. It should be appreciated however that fuel may be supplied to the carburetor from a fuel reservoir separate from the carburetor. A fuel delivery line 30 extends from the float chamber 22 into the induction passage 23 of the carburetor 20. A solenoid valve 40 controls the flow of fuel from the float chamber 22 to the induction passage 23. A check valve 60 provides a balanced distribution of fuel to the cylinders of the engine 10 and prevents fuel from flowing back from the induction passage 23 to the float chamber 22 through the fuel delivery line 30.

An electronic control unit 70 receives a signal indicative of the engine temperature from an engine temperature sensor 50. The engine temperature sensor 50 provides a signal indicative of the engine temperature by sensing, for example, the temperature of the engine coolant. The electronic control unit 70 controls the duty cycle of the solenoid valve 40 based on the temperature sensed by the temperature sensor 50. The duty cycle of the solenoid valve 40 is the percentage of the opening time of the solenoid valve in relation to its fixed cycle time.

The solenoid valve 40 has a fixed frequency of, for example, 10 Hz and the electronic control unit 70 controls the duty cycle of the solenoid valve 40 to increase the amount of fuel delivered to the induction passage 23 through the fuel delivery line 30 during cold start. The electronic control unit 70 reduces the duty cycle of the solenoid valve 40 at a constant rate until it reaches zero. This prevents an over enrichment of fuel mixture once the engine has started, which may otherwise damage the ignition components (spark plugs) or reduce the engine performance.

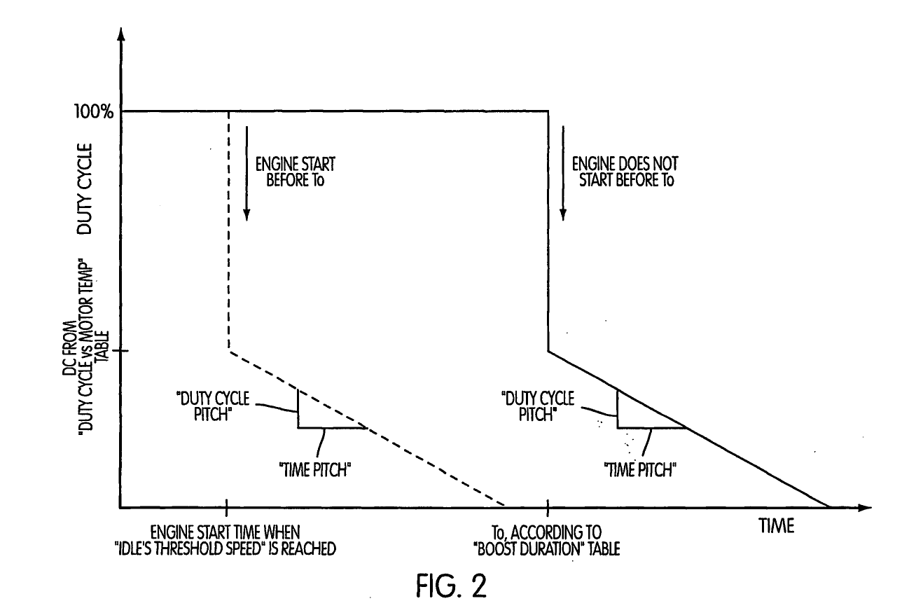

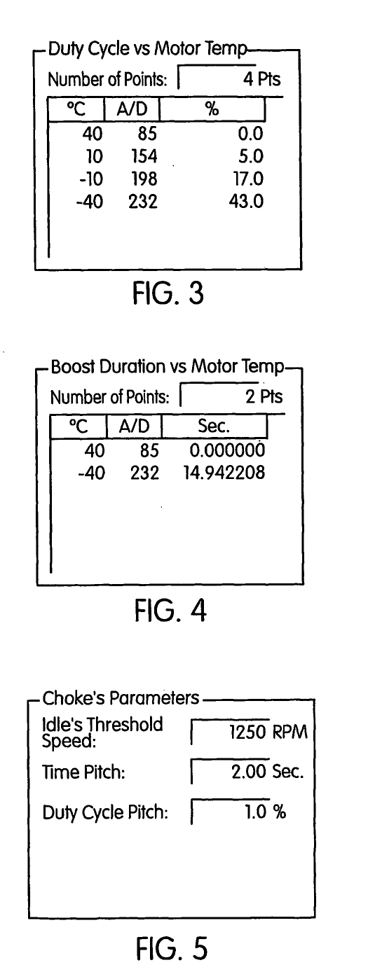

Referring to FIG. 2, the duty cycle at the beginning of engine cranking is set at 100%, regardless of the engine temperature, to minimize the crank time before engine start-up. Immediately upon engine start, defined as the electronic control unit 70 detecting an engine speed corresponding to an idle threshold speed, indicated in FIG. 5, the electronic control unit 70 reduces the duty cycle of the solenoid valve 40 to a value associated with the temperature determined by the sensor 50 that is stored in a table, such as the table shown in FIG. 3. Although the duty cycle is shown in FIG. 2 as being changed from 100% to the associated value in zero time, it should be appreciated that the change in duty cycle does require some time, albeit a very short time. The table may be stored, for example, in a memory of the electronic control unit 70. The A/D value in FIG. 3 is an analog to digital parameter readable by the electronic control unit 70. The idle threshold speed shown in FIG. 5 is empirically determined.

The rate at which the duty cycle will decrease after engine start will be determined by dividing the duty cycle pitch by the time pitch, shown in FIG. 5. For example, the duty cycle will be reduced 1% every two seconds. The duty cycle pitch and the time pitch are empirically determined for the vehicle and are not dependent on the temperature.

The duty cycle/motor temp table shown in FIG. 3 includes duty cycle values at four temperatures, ranging from 40° C. to −40° C. The duty cycle values at the four temperatures are empirically determined. Although the table shown in FIG. 3 includes duty cycle values at four temperatures, it should be appreciated that the table may include duty cycle values at any number of temperatures. If the signal from the temperature sensor 50 indicates a temperature that is not stored in the table shown in FIG. 3, the electronic control unit 70 extrapolates a duty cycle value from the table based on the signal provided by the temperature sensor 50.

Referring again to FIG. 2, if the engine does not start before a predetermined boost duration time To, such as the boost duration time shown in the table of FIG. 4, the electronic control unit 70, at time To, will reduce the duty cycle of the solenoid valve 40 to that corresponding to the engine temperature at the beginning of cranking, found in FIG. 3, and continue to reduce it at the constant rate determined by the duty cycle pitch and the time pitch of FIG. 5. The boost duration time To is also empirically determined and is temperature dependent Again, assuming that the engine temperature, as determined by the signal from the temperature sensor 50, is not stored in the tables of FIGS. 3 and 4, the electronic control unit 70 extrapolates a value of the temperature and the boost duration time To. Thereafter, regardless of the start time of the engine after the boost duration time To, the duty cycle of the solenoid valve 40 continues to decrease at the constant rate until it reaches zero.

The automatic carburetor enrichment system according to the present invention reduces cranking time during cold start and eliminates the need for driver input during cold start. The automatic carburetor enrichment system according to the present invention also prevents engine stalling without assistance from the operator during the warm up phase and provides a simpler, more cost effective and reliable carburetor enrichment than current systems, including those that use an air pump. The automatic carburetor enrichment system according to the present invention provides self-drowning protection without the use of an electronic idle switch and eliminates the risk of engine drowning when the engine is cranked with the choke ON and the ignition switches OFF.

Although the present invention has been described with reference to the exemplary embodiments described above, it should be appreciated that various modifications would be within the level of ordinary skill in the art. For example, a manual choke may be included as a backup to the automatic carburetor enrichment system. As another example, although the electronic control unit has been described as determining the engine temperature at the beginning of engine start, it should be appreciated that the electronic control unit may monitor the engine temperature a plurality of times, or even continuously, during engine start and control the solenoid valve duty cycle based on the plural signals or the continuous signal from the temperature sensor. Additionally, although the duty cycle has been described as reduced at a constant linear rate, it should be appreciated that the duty cycle may be reduced at an exponential or logarithmic rate. Accordingly, the scope of the protection sought by the grant of Letters Patent is defined by the Claims appended hereto.

1. A carburetor enrichment system that controls an air-fuel ratio of an air-fuel mixture supplied to an internal combustion engine during cold start, the engine having a carburetor, that is supplied fuel from a fuel reservoir, and includes an induction passage, the carburetor enrichment system comprising:
a sensor that provides a signal indicative of an engine temperature;
a fuel line connected between the fuel reservoir and the induction passage;
a solenoid valve disposed in the fuel line; and
a controller that receives the signal and sets a duty cycle of the solenoid valve associated with the engine temperature to increase the air-fuel ratio of the air-fuel mixture.

2. A carburetor enrichment system according to claim 1, wherein the controller sets the duty cycle of the solenoid valve at one of a) an engine start time and b) a boost duration time associated with the engine temperature.

3. A carburetor enrichment system according to claim 2, wherein the engine start time is determined when the engine reaches a predetermined idle threshold speed.

4. A carburetor enrichment system according to claim 2, wherein the controller stores a plurality of engine temperatures and associated boost duration times.

5. A carburetor enrichment system according to claim 1, wherein the controller stores a plurality of engine temperatures and associated duty cycles.

6. A carburetor enrichment system according to claim 2, wherein the controller reduces the duty cycle of the solenoid valve at a predetermined rate after one of a) the engine start time and b) the boost duration time.

7. A carburetor enrichment system according to claim 6, wherein the predetermined rate is constant.

8. A carburetor enrichment system according to claim 2, wherein the duty cycle of the solenoid valve is a maximum duty cycle prior to one of a) the engine start time and b) the boost duration time.

9. A carburetor enrichment system that controls an air-fuel ratio of an air-fuel mixture supplied to an internal combustion engine during cold start the engine having a carburetor, that is supplied fuel from a fuel reservoir, and includes an induction passage, the carburetor enrichment system comprising:
a sensor that provides a signal indicative of an engine temperature;
a fuel line connected between the fuel reservoir and the induction passage;
a solenoid valve disposed in the fuel line; and
a controller that sets a duty cycle of the solenoid valve to a maximum duty cycle, receives the signal, reduces the duty cycle from the maximum duty cycle to a determined duty cycle associated with the engine temperature, and further reduces the duty cycle at a predetermined rate after one of a) engine start and b) a boost duration time associated with the engine temperature.

10. A carburetor enrichment system according to claim 9, wherein the engine start time is determined when the engine reaches a predetermined idle threshold speed.

11. A method of controlling an air-fuel ratio of an air-fuel mixture supplied to an internal combustion engine during cold start, the engine having a carburetor including an induction passage that is supplied fuel by a fuel line connected between a fuel reservoir and the induction passage, the fuel line having a solenoid valve disposed therein, the method comprising:
determining an engine temperature; and
setting a duty cycle of the solenoid valve associated with the engine temperature to increase the air-fuel ratio of the air-fuel mixture.

12. A method according to claim 11, wherein setting the duty cycle occurs at one of a) an engine start time and b) a boost duration time associated with the engine temperature.

13. A method according to claim 12, wherein the engine start time is determined when the engine reaches a predetermined idle threshold speed.

14. A method according to claim 12, wherein a plurality of engine temperatures are associated with a plurality of boost duration times.

15. A method according to claim 11, wherein a plurality of engine temperatures ar associated with a plurality of duty cycles.

16. A method according to claim 12, further comprising reducing the duty cycle of the solenoid valve at a predetermined rate after one of a) the engine start time and b) the boost duration time.

17. A method according to claim 16, wherein the predetermined rate is constant.

18. A method according to claim 12, wherein the duty cycle of the solenoid valve is a maximum duty cycle prior to one of a) the engine start time and b) the boost duration time.

19. A method for controlling an air-fuel ratio of an air-fuel mixture supplied to an internal combustion engine during cold start the engine having a carburetor including an induction passage that is supplied by a fuel line connected between a fuel reservoir and the induction passage, the fuel line having a solenoid valve disposed therein, the method comprising:
determining an engine temperature;
setting a duty cycle of the solenoid valve to a maximum duty cycle;
reducing the duty cycle from the maximum duty cycle to a determined duty cycle associated with the engine temperature; and
further reducing the duty cycle at a predetermined rate after one of a) engine start and b) a boost duration time associated with the engine temperature.

20. A method according to claim 19, wherein the engine start time is determined when the engine reached a predetermined idle threshold speed.
